(19) United States
(12) Patent Application Publication
(10) Pub. No.: US 2020/0041676 A1
(43) Pub. Date: Feb. 6, 2020

(54) FAST PLANE-WAVE REVERSE TIME MIGRATION

(71) Applicant: Saudi Arabian Oil Company, Dhahran (SA)

(72) Inventors: WANG XIONGWEN, BEIJING (CN); LUO YI, DHAHRAN (SA); LIU HONGWEI, AL-KHOBAR (SA)

(21) Appl. No.: 16/050,244

(22) Filed: Jul. 31, 2018

(51) Int. Cl. G01V 1/30; G01V 1/32; G01V 1/28; E21B 49/00

(52) U.S. Cl. CPC G01V 1/301; G01V 1/32; E21B 47/0002; E21B 49/00; G01V 2210/679; G01V 1/282

(57) ABSTRACT

Reverse time migration (RTM) performed on plane-wave seismic exploration survey results avoids long delay time problems in processing of plane-wave reverse time migration. The plane-wave sources and gathers are wrapped periodically, which significantly reduces computation cost of plane-wave reverse time migration. Circular convolution is performed without having to determine in advance the exact signals being convolved. Computer resources for preparing and storing the two signals in advance are significantly reduced from those previously required.

### BACKGROUND OF THE INVENTION

### 1. Field of the Invention

The present invention relates to geophysics, and more particularly to acquisition and processing of seismic survey results in order to more accurately indicate subsurface formation structure from reverse time migration of the survey results, and to thus determine areas of interest for drilling wells.

### 2. Description of the Related Art

For determining areas of interest for drilling wells in subsurface formations, analysis of the results of seismic exploration surveys plays an important part. The seismic survey results when properly analyzed indicate formations of interest, whether on land or offshore.

Seismic data analysis is complex because the recorded data is the result of interrelated physical processes and noise. Velocity models of the formation being explored in areas of interest are employed due to simulate the acquired data. The velocity models are representations of wave propagation velocity inside the formation. Reflected real or simulated data may be migrated in time or depth (i.e., re-localized at their positions parameterized in depth or in vertical time) using the formation's velocity model. If the layers are more or less homogenous, forming an accurate velocity model is a relatively simple process.

However, in reality the layers are not homogenous. Significant geophysical features must be considered. Such features include anisotropic velocity variations, complex geological formations such as salt and basalt structures, heavily faulted zones, anisotropic environments due to sedimentation or fracturing, over-thrusts, shallow gas, and the like. Seismic energy wave velocity may also depend on the type of rock and depth, since seismic energy waves typically travel with higher velocity through rocks under pressure.

Reverse time migration (or RTM) is used for generating final images of subsurface structures based on the seismic survey results. Reverse time migration is also used for adjusting structural boundaries during building of a velocity model. Reverse time migration is a seismic methodology for processing and analyzing seismic survey traces using two-way wave equation migration.

Reverse time migration is performed in order to obtain accurate imaging in and below areas having either great structural complexities or large seismic velocity changes. The reverse time migration processing methodology involves obtaining numerical solutions to the two-way wave equation. Reverse time migration has traditionally been considered impractical in part to high computational costs.

Conventional plane-wave reverse time migration suffers from long delay time problems. The problem results from the time difference in activation time between the first and last source in a plane-wave gather. This problem greatly increases the computation cost of plane-wave reverse time migration and hinders its application and practice in industry.

One possible approach to overcome this issue has been to wrap the plane-wave sources and gathers periodically. The wrapped sources and gathers generate periodical source and receiver wavefields and their cross-correlation provides the migration results. Traditionally, the periodical wavefields were calculated by obtaining Green's functions which—represents the displacement field resulting from the seismic energy wave motion. The Green's functions of the periodical wavefields were processed by circular convolution with the plane-wave sources or gathers of the seismic survey results.

Nevertheless, solving the wave equation by finite differencing computer processing in reverse time migration, solving the time domain Green's function and storing the results still has, so far as is known, proven very expensive in terms of computation processing time.

U. S. Published Application No. 2016/0282490 described one technique of reverse time migration, based on full waveform inversion determination of Green's functions for the purpose of the reverse time migration. Various combinations of back- and forward propagated wavefields were used in zero time lag deconvolution for velocity model perturbation/correction. The described technique was also apparently time-consuming in terms of computer processing time, since trade-offs in accuracy of results were provided as alternatives to processing time and complexity.

U. S. Published Application No. 2015/0036461 described the lack of capabilities of migration methods which reverse time migration was proposed to address. A phase-encoding algorithm was used with a harmonic-source migration, to implement a phase shifts in the time domain. The phase-encoding was proposed to long time delay problems attendant in plane-wave migration.

U. S. Published Application No. 2012/0075954 described in the context of reverse time migration a computationally intensive technique. The technique involved convolution over three-dimensional vectors from both the seismic source and receiver traces.

### SUMMARY OF THE INVENTION

Briefly, the present invention provides a new and improved method of acquisition and processing of seismic traces resulting from a seismic survey to produce an image of a subsurface area indicating subsurface formation structure. A seismic survey is conducted to obtain a series of seismic traces related to the subsurface area as an area of interest for drilling wells in subsurface formation structure. The series of seismic traces are transferred for processing, and the transferred series of seismic survey traces are converted to plane-wave source traces and plane-wave gathers. The transformed plane-wave source traces and plane-wave gathers are then transformed to periodical wavefields. Reverse time migration of the transformed wavefields is then performed by linear convolution of the transformed periodical wavefields. An output display of an image of the subsurface area is formed indicating subsurface formation structure from the reverse time migrated, transformed periodical wavefields.

### BRIEF DESCRIPTION OF THE DRAWINGS

FIG. 1 is a schematic diagram of an example positioning of seismic energy receivers over a survey grid for performing a seismic survey for an area of interest.

FIG. 1A is an enlarged view of an encircled portion indicated at 1A within FIG. 1.

FIG. 2 is a schematic diagram of the process of fast plane-wave reverse time migration of seismic survey results for determining areas of interest for drilling wells in subsurface formations according to the present invention.

FIG. 3 is a schematic diagram of a seismic survey indicating arrival times of seismic energy at seismic receivers of plane-waves.

FIGS. 4 and 5 are schematic diagrams of the seismic survey of FIG. 3 indicating arrival times of seismic energy at seismic receivers of plane-waves as a result of the present invention.

FIG. 6 is a plot of a plane wave source signal as a function of time and distance before wrapping of the source signal according to the present invention.

FIG. 7 plot of the plane wave source signal of FIG. 6 after wrapping of the source signal according to the present invention.

FIG. 8 is a schematic diagram of a processing workflow showing in more detail a portion of the workflow of FIG. 2.

FIG. 9 is a diagram of example seismic waveforms illustrative of the present invention.

FIG. 10 is a plot of migration results of seismic gathers processed by conventional shot domain reverse time migration.

FIG. 11 is a plot of migration results of seismic gathers processed according to the present invention.

FIG. 12 is a schematic diagram of a data processing system for fast plane-wave reverse time migration of seismic survey results for determining areas of interest for drilling wells in subsurface formations according to the present invention.

### DETAILED DESCRIPTION OF THE PREFERRED EMBODIMENTS

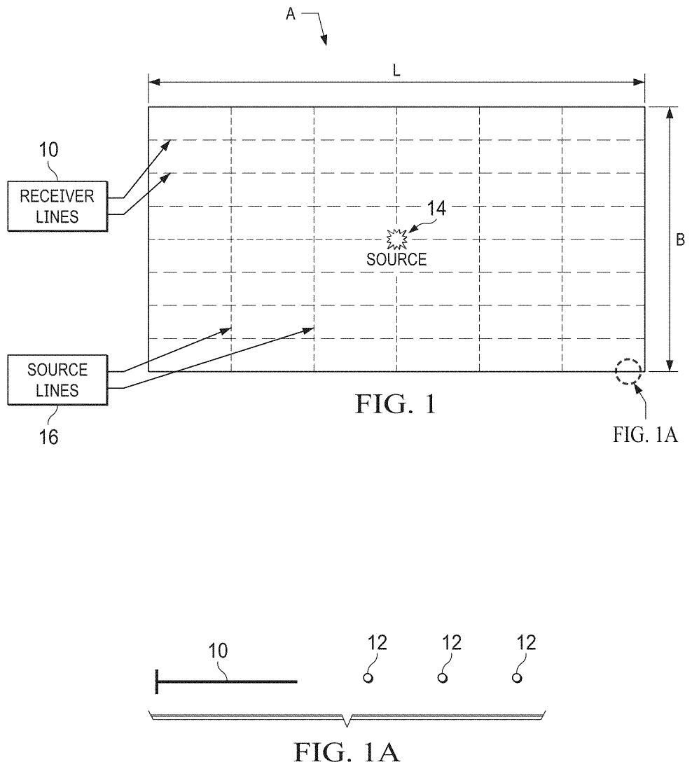

In the drawings, FIG. 1 illustrates deployment of an array or patch A of seismic energy receivers or sensors at fixed locations across the length indicated by an arrow L and breadth or width B of a survey area of interest. Because of the number of receivers, their deployment over the array A is indicated schematically by a number of spaced lines 10 extending along the length L of the array A. The seismic survey is conducted in an area of interest for drilling wells in subsurface formations for exploration and production of hydrocarbons.

Example individual ones of a number of spaced seismic energy receivers 12 are shown schematically along survey lines 10, each such line composed of the spaced receivers 12 as indicated schematically in FIG. 1A. The individual receivers 12 are geophones mounted at fixed locations in the array A for land surveys and hydrophones for surveys in bodies of water.

During seismic survey operations, a source of energy such as one shown schematically at 14 (FIG. 1) is activated or fired into the ground by seismic sources positioned along source lines 16 at a number of particular locations over the array A according to a survey plan. Each individual instance of source activation known as a “shot”. The energy from a seismic survey shot is a non-periodic time decaying impulse signal which propagates as a pressure wave and as a shear wave through the ground.

The propagating seismic energy pressure wave is reflected from structures in the underlying geology. The reflected return energy is measured by the sensors/receivers deployed at known positions over the survey area of interest. The collected measurements of return energy are also non-periodic signals. After appropriate processing of the collected measurements, indications of the presence, extent and characteristics of subsurface formations in the earth are obtained. The return energy measurements are frequently referred to as seismic data or seismic survey data. Individual ones of the collected return pressure wave energy measurements at a particular receiver location are referred to as seismic traces.

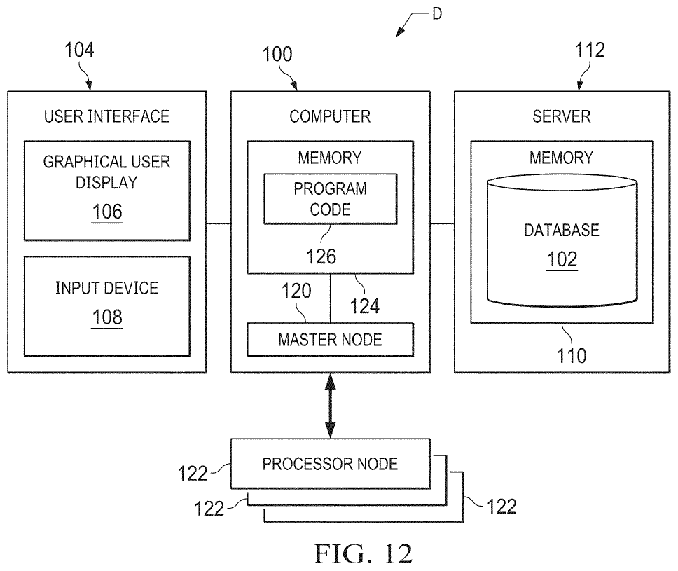

The process of activating the source 14 or sources to form seismic shots is repeated at a number of specified locations over the survey area of interest. The seismic energy from the sources during each of the shots travels through the earth to be obtained and recorded as seismic traces in the sensors/receivers 14 of the array A. The recorded traces are collected measurements of seismic energy over time which are transferred to a data processing system D (FIG. 12) for subsequent processing and analysis, as will be described.

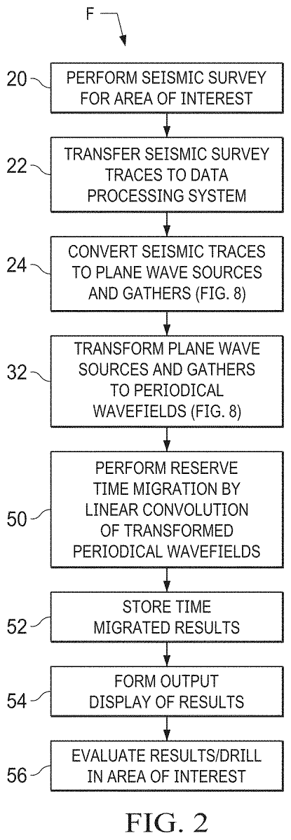

FIG. 2 is a schematic diagram of a workflow F outlining a preferred embodiment of a sequence according to the present invention for acquisition and processing of seismic survey results in order to more accurately indicate subsurface formation structure from reverse time migration of the survey results, and to thus determine areas of interest for drilling wells.

As indicated at step 20 in FIG. 2, acquisition and processing of seismic survey results according to the present invention begins with one or more seismic surveys being conducted in area of interest for drilling wells in subsurface formations for exploration and production of hydrocarbons. The seismic survey results are in the form of seismic traces which are the response of the earth formations to non-periodic time decaying impulse signals of seismic shots. The seismic traces thus represent the responses of the subsurface formations to reflections during the travel of pressure wave seismic energy from seismic sources 14 to the sensor geophones 12 of the array A located in the area of interest, whether on land or beneath a body of water.

The seismic survey traces of both the impulse signals of source emitted energy and the responses detected by the geophones are recorded and converted into digital form. As indicated at step 22, the seismic survey traces are then transferred to a data processing system, such as data processing system D shown in FIG. 12.

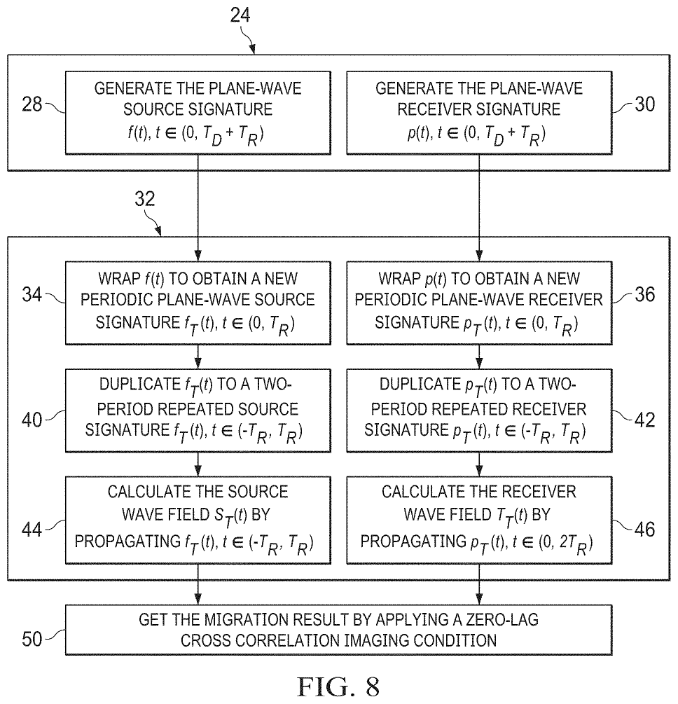

The seismic survey traces are then subjected to processing in the data processing system D beginning with a step 24 in which the seismic survey traces are converted to plane-wave source traces and plane-wave receiver gathers. According to the present invention, the conversion during step 24 is performed separately in parallel processing among processor nodes of the data processing system D during steps 28 and 30, as shown in FIG. 8. During step 28, a plane wave source signature f (t) is generated where the time t is within a specified time range as follows: t∈(0,T_{D}+T_{R}). During step 30, a plane wave receiver signature p(t) is generated where the time t is within a specified time range as follows: t∈(0,T_{D}+T_{R}).

The conversion during steps 28 and 30 of step 24 is done by a process known as slant stacking of the collected seismic traces. During slant stacking, the energy levels of the seismic traces in a gather are summed or stacked, applying linear moveout and summing amplitudes over the offset axis. This is done by shifting the traces in time according to the distance of sensor locations from the source location or surface point along the offset axes for that gather and then summing the time-shifted traces. The plane-wave source traces and the plane-wave receiver gathers so formed represent the responses of the subsurface formations which would be present in response to travel of seismic energy by a downwardly moving planar two-dimensional seismic wave from the earth surface.

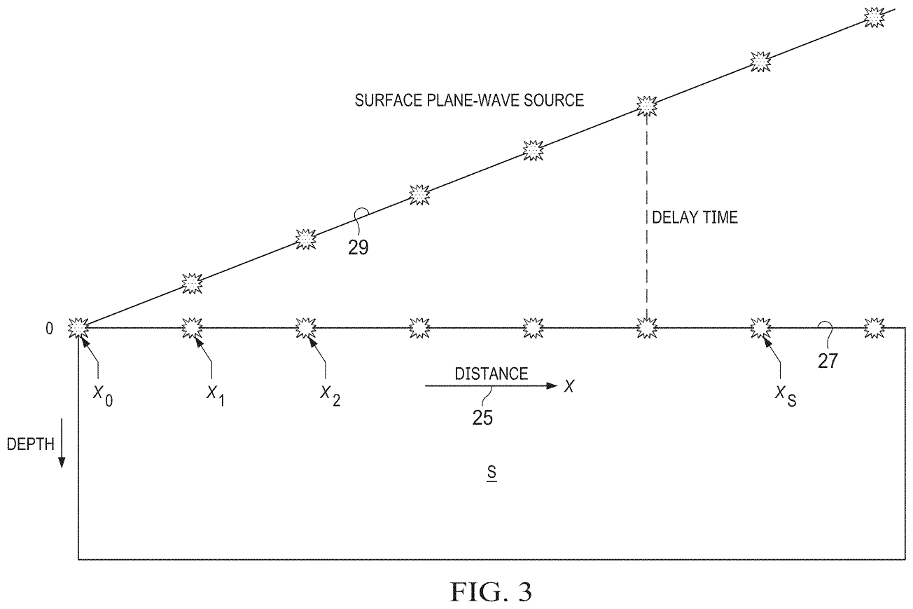

FIG. 3 is a composite diagram illustrating in its lower portion a cross-sectional segment S of the subsurface earth in terms of depth as indicated extending laterally along and offset seismic line of profile as a function of distance x as indicated by an arrow 25. In FIG. 3, a series of source locations or shot points x₁, x₂, . . . xₛ are indicated at spaced positions along the offset seismic line of profile from an initial shot point location x₀. FIG. 3 also shows in an upper portion above the earth segment and above an offset seismic line of profile 27 an upwardly inclining line 29. The upwardly inclining line 29 indicates the lengths or amounts of time delay required to be introduced as a function of distance from the initial shot point location x₀ to the seismic source traces formed at the initial shot point location x₀ to accurately include that seismic source trace in a seismic source gather at each of a succession of the shot points x₁, x₂ . . . xₛ along the offset seismic line of profile 27. As indicated in FIG. 3, there are correspondingly longer or shorter time delays for other shot points locations x depending on distance from the shot point location x₀.

The time delays schematically indicated in FIG. 3 greatly increase the computation cost in terms of the computer processing time and computer usage costs of plane-wave reverse time migration according to known methods. The time delays are a result of having to compensate for time differences during the formation of the plane-wave the source and receiver gathers, as illustrated in FIG. 3. The increase in computation costs is in turn a significant impediment to plane-wave reverse time migration.

Next during step 32 (FIG. 2), the non-periodic time decaying impulse signals to plane-wave source traces and plane-wave receiver gathers formed as a result of step 24 are transformed to periodical wavefields. As was the case with step 24, the transformation of the source traces and plane-wave receiver gathers in step 32 to periodical wavefields is performed separately in parallel processing among processor nodes of the data processing system D during steps 34 and 36, as shown in FIG. 8.

During step 34, the plane wave source signature f(t) generated during step 28 is a wrapped to obtain a new periodic plane-wave source signature f_{T}(t) as follows: f_{T}(t), t∈(0,T_{R}) where the time t is within a specified time range as follows: t∈(0,T_{R}). During step 36, the plane wave receiver signature p(t) generated during step 30 is a wrapped to obtain a new periodic plane-wave receiver signature p_{T}(t) as follows: p_{T}(t), t∈(0,T_{R}) where the time t is within a specified time range as follows: t∈(0,T_{R}).

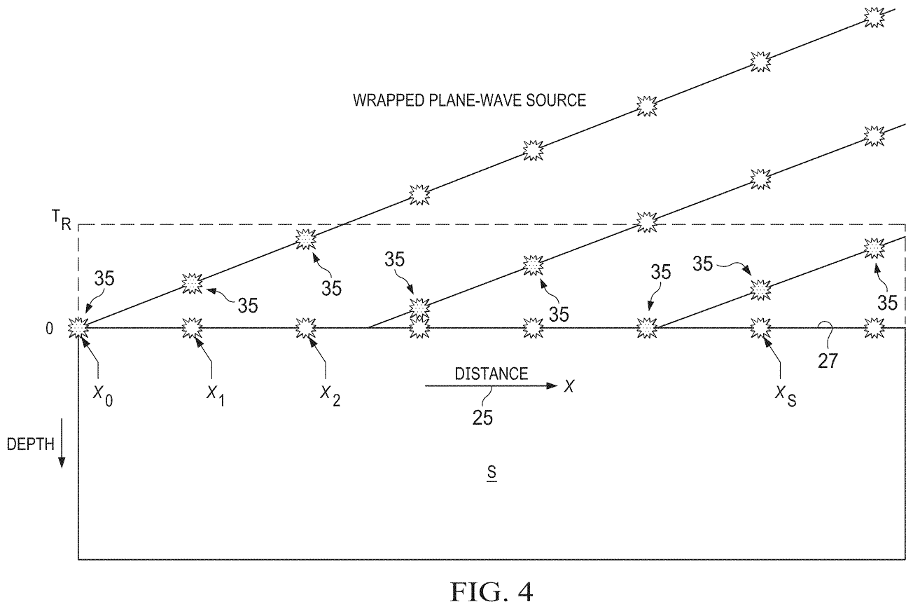

FIG. 4 illustrates schematically the results of transforming the plane-wave source gathers to periodical wavefields during step 34 for the same segment of the earth shown in FIG. 3 for a plane-wave source for a time duration extending from a time t=0 until a specified time T_{R}. The time T_{R} is specified according to the type of formations known or likely to be present at depths of interest in the earth which is the subject of the seismic survey. The time T_{R} represents a time length corresponding to the difference in activation time for each of the seismic sources in the gather shown in FIG. 3.

Thus as shown in FIG. 4, during the time t=0 until a time T_{R} eight source gathers are converted to periodical wavefields as indicated at locations 35 positioned at increasing distances x from the initial source shot point location x₀. The eight periodical wavefields of source gathers occur during the time T_{R} as indicated at the locations 35 along the offset line as shown in FIG. 4. The symbols at locations 35 denote the presence of converted periodical wavefields as real shots in wave modeling within the shortened duration of the difference in activation time T_{R}. FIG. 4 thus shows a wrapped plane-wave source wavefield in which the time period or periodicity of the source wavefield has been reduced to the time length represented by the time T_{R}.

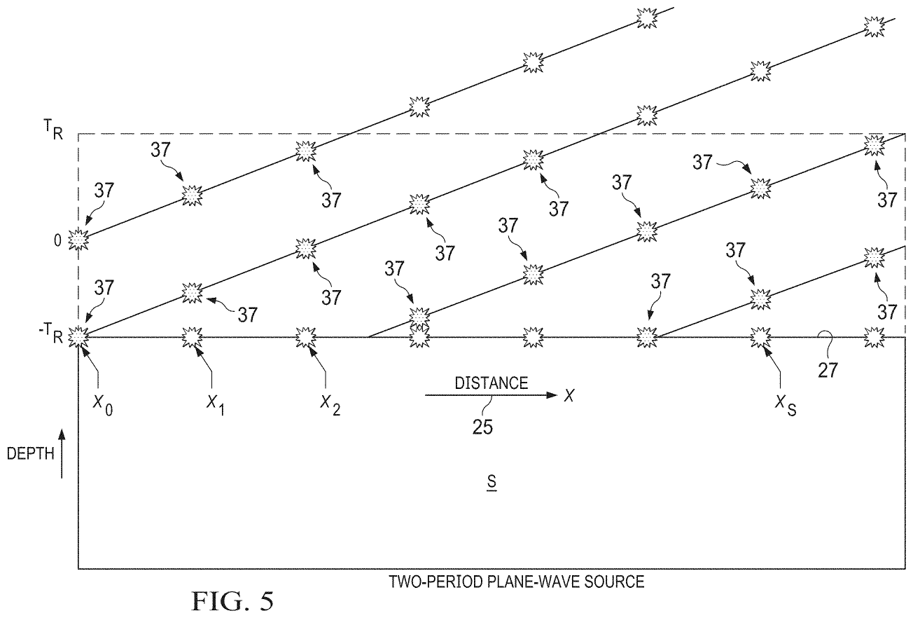

FIG. 5 illustrates schematically the results of transformation of the plane-wave gathers to periodical wavefields during step 34 for the same segment of the earth shown in FIG. 3 for a two-period over a time duration extending from a time −T_{R} until a time T_{R}, or twice the time T_{R}. Thus as shown in FIG. 5, during a time interval extending from a time −T_{R} until a time T_{R}, sixteen source gathers are wrapped within the shortened duration is the difference in activation time. FIG. 5 illustrates a two-period plane-wave source used in wave modeling according to the present invention.

FIG. 4 illustrates schematically the results of transforming the plane-wave source gathers to periodical wavefields during step 34 for the same segment of the earth shown in FIG. 3 for a plane-wave source for a time duration extending from a time t=0 until a specified time T_{R}. The time T_{R} is specified according to the type of formations known or likely to be present at depths of interest in the earth which is the subject of the seismic survey. The time T_{R} represents a time length corresponding to the difference in activation time for each of the seismic sources in the gather shown in FIG. 3.

Thus as shown in FIG. 4, during the time t=0 until a time T_{R} eight source gathers are converted to periodical wavefields as indicated at locations 35 positioned at increasing distances x from the initial source shot point location x₀. The eight periodical wavefields of source gathers occur during the time T_{R} as indicated at the locations 35 along the offset line as shown in FIG. 4. The symbols at locations 35 denote the presence of converted periodical wavefields as real shots in wave modeling within the shortened duration of the difference in activation time T_{R}. FIG. 4 thus shows a wrapped plane-wave source wavefield in which the time period or periodicity of the source wavefield has been reduced to the time length represented by the time T_{R}.

FIG. 5 illustrates schematically the results of transformation of the plane-wave gathers to periodical wavefields during step 34 for the same segment of the earth shown in FIG. 3 for a two-period over a time duration extending from a time −T_{R} until a time T_{R}, or twice the time T_{R}. Thus as shown in FIG. 5, during a time interval extending from a time −T_{R} until a time T_{R}, sixteen source gathers as indicated at 37 are wrapped within the shortened duration is the difference in activation time. FIG. 5 illustrates a two-period plane-wave source used in wave modeling according to the present invention.

According to the present invention, the plane-wave seismic gathers formed during step 24, each seismic trace of the plane-wave sources and receivers gathers are subjected to processing to transform the gathers to periodical wavefields according to what is known as wrapping. During wrapping of the trace gathers, the traces of time length T are divided into a succession of time segments of reduced period or time duration T_{R} as indicated in FIG. 4. The time T_{R} in its shortened duration is the difference in activation time for each of the seismic sources in the gather. Thus as shown in FIG. 4, during the time T_{R} eight source gathers are wrapped within the shortened duration is the difference in activation time.

Step 32 as indicated in FIG. 8 further includes steps 40 and 42 forming new plane-wave source and the plane-wave receiver signature wavefields. Step 40 involves duplicating the plane-wave source signature f_{T}(t) to a two-period repeated source signature f_{T}(t), t∈(−T_{R}, T_{R}) where the time t is within a specified two-period time range as follows: t∈(−T_{R}, T_{R}). Step 42 involves duplicating the plane-wave receiver signature p_{T}(t) to a two-period repeated source signature p_{T}(t), t∈(−T_{R}, T_{R}) where the time t is within a specified two-period time range as follows: t∈(−T_{R}, T_{R}).

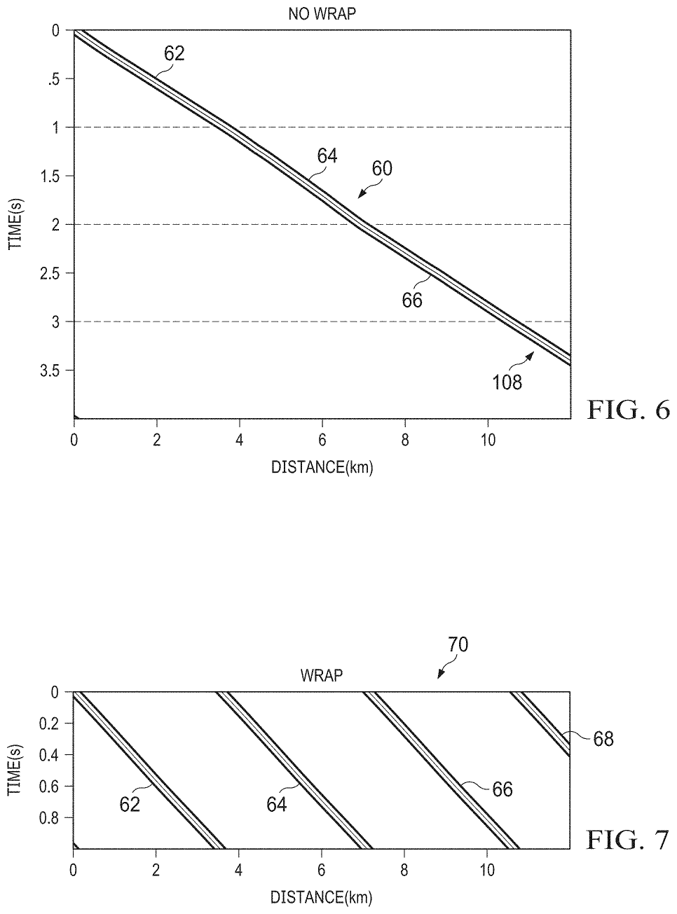

According to the present invention, the plane-wave sources and gathers are periodically processed by being wrapped, thus making both source and receiver wavefields periodical. With the present invention, a plane wave source signal 60 as shown in FIG. 6 plotted as a function of time and distance, is divided or segmented by being cut into several segments or pieces of a defined time duration or period, beginning with a first cut piece or segment 62. A second piece 64 and other subsequent pieces or segments 66 and 68 of the plane wave source signal 60 are then duplicated or copied into the first segment 62.

For example, the plane wave source signal 60 of FIG. 6 represents the plane wave source signal as a function of time and distance before wrapping. In FIG. 6, the period of time of the seismic signal is 1 second for a simplified example. In the simplified example of FIGS. 6 and 7, the wrapping length is made to be the same time length as the time length of the plane wave source seismic signal 60. Because of time delay, the length of the source signal 60 is 4 seconds.

The wrapping processing incorporates the subsequent segments 64, 66 and 68 into the first segment such as 62 so that the segments are present in a common time interval of 1 second as shown in FIG. 7. The wrapping processing incorporates the subsequent segments 64, 66 and 68 at their original distances, as also shown in FIG. 7. The wrapping operation of plane wave sources and gathers according to the present invention in this manner forms a new wrapped signal such as shown at 70 in FIG. 7, composed of the wrapped segments 62, 64, 66 and 68.

The period or duration of the time interval into which the plane wave source or signal 60 is cut during the wrapping operation of step 34 and also step 36 is of a length determined based on the migration depth specified for the reverse time migration to be performed. As mentioned in the example of FIGS. 6 and 7, one second was used. The period of time selected can be less than or equal to the effective time duration of the seismic signal. The period of time should be no less than the minimum travel time from the recording datum to the maximum depth or the largest angle. The number of pieces or segments into which the plane wave source signal is partitioned or cut is equal to the ratio between the maximum delay time and the period of time. The ratio between the maximum delay time and the period of time is usually from ½ to 1/1, or in percentage terms from 50% to 100%. The segments of time into which the plane wave source signal is cut are usually on the order of several seconds in depth.

Step 32 further includes calculation or determination of a source wavefield s_{T}(t) and a receiver wavefield r_{T}(t). As indicated in FIG. 8, the determination of a source wavefield s_{T}(t) and a receiver wavefield r_{T}(t) is performed separately in parallel processing among processor nodes of the data processing system D during steps 44 and 46. During step 44, source wavefield s_{T}(t) is determined by propagating the periodic plane-wave source signature f_{T}(t) over the two-period time duration as follows: f_{T}(t), t∈(−T_{R}, T_{R}). During step 44, receiver wavefield p_{T}(t) is determined by propagating the periodic plane-wave receiver signature p_{T}(t) over the two-period time duration as follows: p_{T}(t), t∈(−T_{R}, T_{R}).

Next, during step 50, reverse time migration linear convolution is performed of the transformed wavefields resulting from step 38. According to the present invention, the reverse time migration during step 50 is performed by applying a zero-lag cross-correlation imaging condition for linear convolution of the transformed periodical wavefields.

As will be set forth, linear convolution of the intermediate periodical wavefields according to the present invention obtains like results to those obtained from the prior art technique of circular convolution of the original signals, and without the need to perform time-consuming in expensive the computer processing to determine Green's functions necessary for the circular convolution. Linear convolution of the intermediate periodical wavefields according to the present invention obtains such results, in addition, with significant reduction of the number of seismic gathers required to be subject to computer intensive and time consuming convolution processing.

The present invention by linear convolution of the transformed periodical wavefields in the manner described above saves processing time and computation cost. The present invention avoids the requirement of previous methods, which involved circular convolution, as well as computation and storage of the source and receiver wavefields in order to form Green's functions required for circular convolution.

During step 52, the reverse time migration results of linear convolution of the transformed periodical wavefields during step 50 are then stored in memory of the data processing system D. During step 54, the stored reverse time migration results of linear convolution of the transformed periodical wavefields formed as a result of step 50 are made available in the form of output displays from the data processing system D.

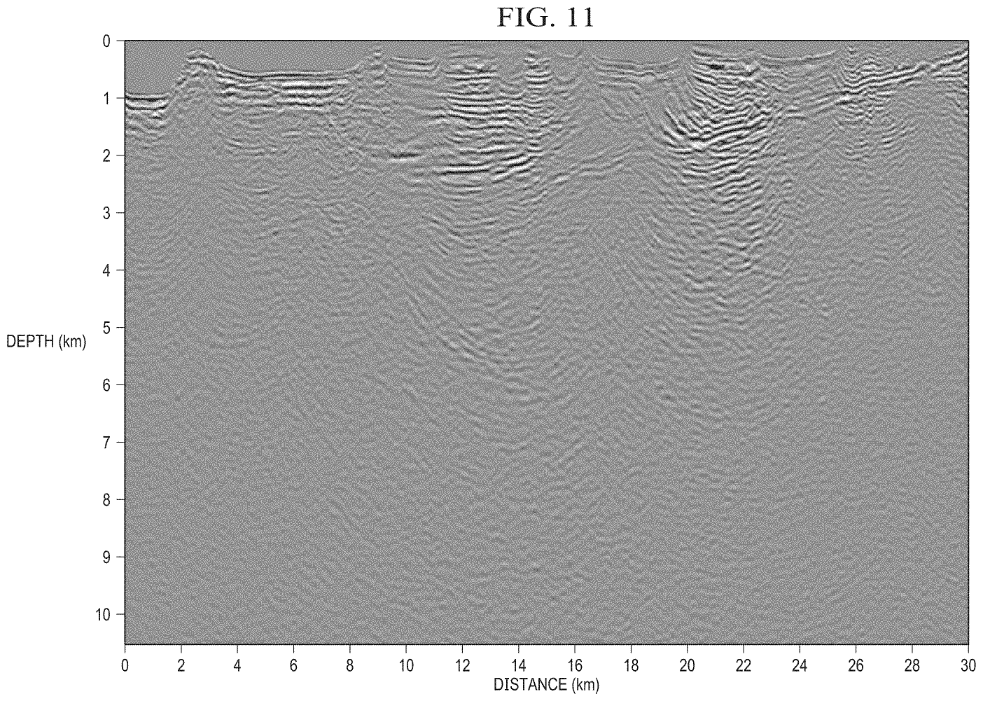

FIG. 11 is a display formed by a data processing system of a migration result formed as a result of step 50 from laboratory data according to the present invention from thirty one plane-wave gathers which have been processed by linear convolution of the transformed periodical wavefields according to the present invention. The stored reverse time migration results of linear convolution of the transformed periodical wavefields represent a final stacked RTM image which is then the basis for generating final images of subsurface structure based on the seismic survey results. The survey results so obtained more accurately indicate subsurface formation structure and thus allow areas of interest to be selected and wells to be drilled in those selected areas. During step 56, output displays of the type shown in FIG. 4 are analyzed and evaluated to determine areas of interest and then for drilling wells.

As has been set forth, the present invention saves processing operating time and the attendant computation cost. This is accomplished with the present invention by forming two-period wavefields for the plane-wave gathers, and replacing the circular convolution processing for reverse time migration with linear convolution. Processing the seismic trace gathers by linear convolution of the periodical wavefields according to the present invention avoids the requirement of prior computation of Green's functions and computer storage of the source and receiver wavefields of the Green's functions so determined.

The effectiveness of processing the seismic trace gathers by linear convolution of the periodical wavefields according to the present invention can be theoretically confirmed in the following manner. The following Equation (1) can be seen to be an expression of the computerized processing performed during circular convolution of two signals:

c(t)=∫₀^{T}s₁(τ)s₂(t−τ)%T)dτ (1)

where s₁(t) and s₂(t) are two input signals whose supports are in [0,T], with T being the recording time of the two input signals; % being a Mod operator (corresponding to the digital sample time interval for digital processing of the two input signals), which represents the remainder as a result of dividing (t−τ) by T; and c(t) is the result of circular convolution.

The circular convolution processing expressed in Equation (1) can be performed in a data processing system either in the frequency domain or in the time domain. In both cases, the input signals s₁(t) and s₂(t) must be known beforehand in order to perform the circular convolution processing. The input signals must both be known, because of the requirement of a value for the Mod operator in Equation (1).

In a number of circumstances, knowing the values of input signals s₁ and s₂ prior to the circular convolution processing according to Equation (1) often has been considered prohibitively expensive. With the present invention, it has been determined that processing the seismic trace gathers by linear convolution of the periodical wavefields of the two input signals input signals s₁ (t) and s₂(t) can be performed by numerical solution of the wave equation without requiring computer processing time be spent in determination of values for a Green's function for input signal s₁. Further, the present invention improves the operation of computers by reducing memory storage capacity requirements. There is no need for additional computer memory to be provided or set aside for storage of a Green's function for input signals₁.

According to the present invention, the linear convolution performed without pre-knowing and storing s₁ or s₂, can also be expressed symbolically in the form of an equation. Noting that the value s₂(t) used in Equation (1) fall in a time range extending over a time duration from times [−T,T), a wavefield function ŝ₂(t) of two cycles of time length 2 T for such a time range can be defined in the following manner:

$${\hat{s}}_{2} ( t ) = \{ \begin{matrix}{s}_{2} ( t ) , & t ∈ [ 0 , T ) \\ {s}_{2} ( t + T ) , & t ∈ [ - T , 0 )\end{matrix} \qquad ( 2 )$$

Merging Equation (2) into Equation (1), a symbolic expression of the linear convolution processing operation performed in the data processing system D is of the following form:

c(t)=∫₀^{T}s₁(τ)ŝ₂(t−τ)dτ (3)

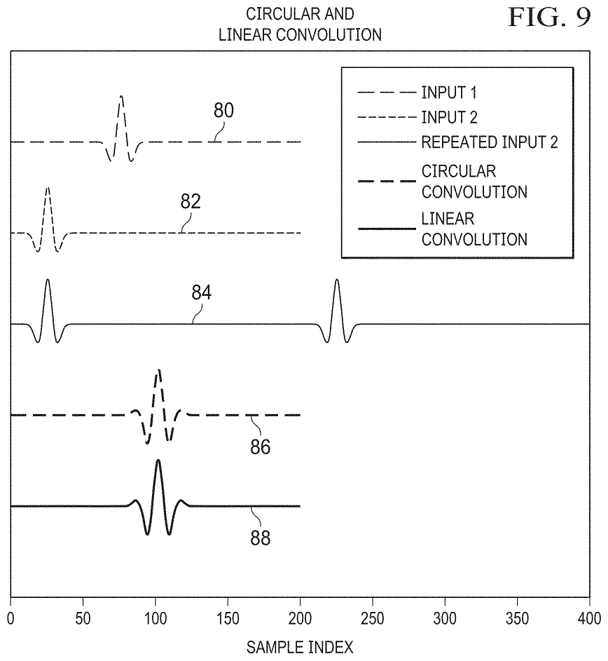

It can be demonstrated that Equations (1) and (3) produce identical results, despite they are obtained from two different kinds of convolution operations. FIG. 7 is a display of comparative results from processing a simplified example waveform (in the form of what is known as a Ricker wavelet) according to the present invention and according to prior art circular convolution. Considering FIG. 9, a waveform 80 is a plot of an example input signal s₁₍ₜ₎ as a function of time. Similarly, a waveform 82 is a plot of an example input signal s₂(t). Further, a waveform 84 is a plot of an signal ŝ₂(t) which is a transformed wavefield formed as a transformation of a two-period signal s₂(t) according to step 28. In FIG. 7, a waveform 86 is a plot of a waveform c(t) determined by circular convolution, while a waveform 88 is a plot of a waveform c(t) determined by linear convolution according to the present invention. The waveforms 86 and 88 representing the two convolution results can be seen to identical.

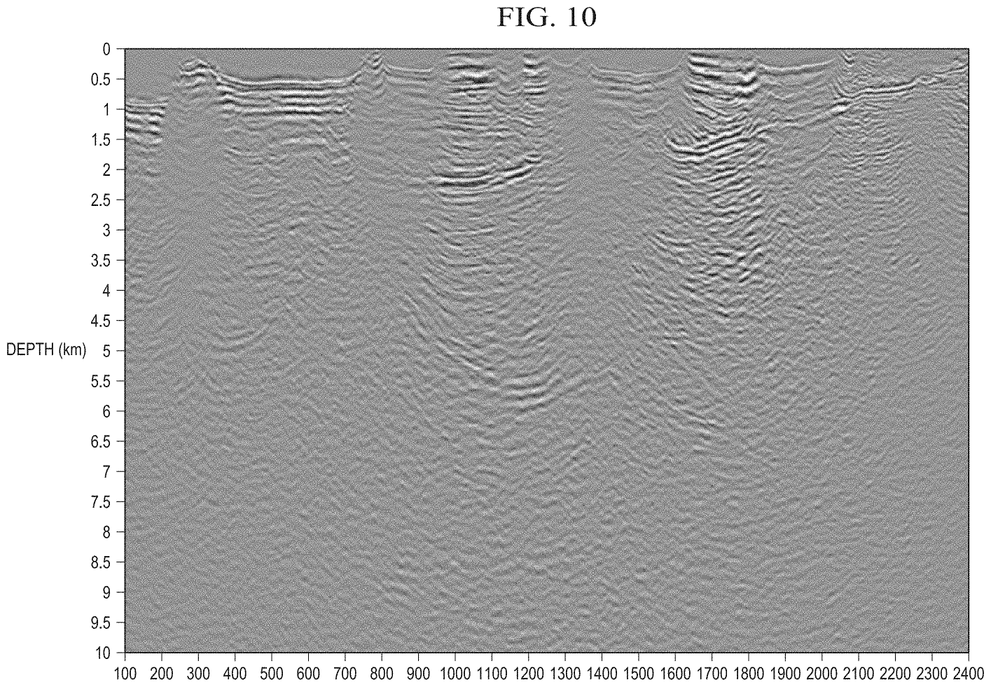

Comparative results have also been obtained from conventional shot domain reverse time migration with circular convolution and from processing the seismic trace gathers by linear convolution according to the present invention. FIG. 10 is a display formed by a data processing system of a migration result formed laboratory data utilizing conventional circular convolution from 1375 shot gathers by conventional shot domain reverse time migration. As has been mentioned, FIG. 11 is a display formed by a data processing system of a migration result formed as a result of step 50 from laboratory data according to the present invention from thirty one plane-wave gathers which have been processed by linear convolution of the transformed periodical wavefields according to the present invention.

It can be seen from visual inspection that the displays of FIG. 10 and FIG. 11 are almost identical. However, it is to be noted that the number of gathers (1,375) being migrated in shot domain reverse time migration to obtain the display of FIG. 10 using circular convolution is about forty five times (1,375/31) more than the thirty one plane-wave gathers required for the display of FIG. 11 from linear convolution of the transformed periodical wavefields according to the present invention.

It can thus be seen that the present invention wraps the plane-wave sources and gathers periodically and makes both the source and receiver wavefields periodical. The present invention avoids computation time requirements of the conventional circular convolution. As has been set forth, this is accomplished with linear convolution and by making two-period intermediate wavefields to obtain the results of plane-wave reverse time migration, as symbolically expressed by Equation (2) above. Linearly convolving intermediate wavefields according to the present invention has been shown to obtain virtually identical results as those obtained by circular convolution of the original signals. Further, this is accomplished with a materially reduced number of gathers needing to be migrated in shot domain reverse time migration.

As illustrated in FIG. 10, the data processing system D includes one or more central processing units or CPU's 100. The CPU or CPU's 100 has associated therewith a reservoir memory or database 102 for general input parameters, core sample data from wells, cell organization data and information, and data processing results. A user interface 104 operably connected with the CPU 100 includes a graphical display 106 for displaying graphical images, a printer or other suitable image forming mechanism and a user input device 108 to provide a user access to manipulate, access and provide output forms of processing results, database records and other information.

The memory or database 102 is typically in a memory 110 of an external data storage computer 112. The database 102 contains data including: the digitized input seismic traces obtained from the seismic survey during step 20; the survey plan representing the arrangement and placement of the seismic sources and receivers in the array A shown in FIG. 1; and related general survey and processing input parameters.

The CPU or computer 100 of data processing system D includes a master node 120 and a plurality of the processor nodes 122 which operate under control of the master node 120. An internal memory 124 is coupled to the master node 120 to store operating instructions, control information and to serve as storage or transfer buffers as required. The data processing system D includes program code 126 stored in memory 124. The program code 126, according to the present invention, is in the form of computer operable instructions causing the master node 120 to transfer data and instructions back and forth for processing by processor nodes 122 to process the seismic survey traces according to the workflow illustrated schematically in FIGS. 2 and 8.

It should be noted that program code 126 may be in the form of microcode, programs, routines, or symbolic computer operable languages that provide a specific set of ordered operations that control the functioning of the data processing system D and direct its operation. The instructions of program code 126 may be stored in memory 124 or on computer diskette, magnetic tape, conventional hard disk drive, electronic read-only memory, optical storage device, or other appropriate data storage device having a computer usable medium stored thereon. Program code 126 may also be contained on a data storage device as a computer readable medium.

The processor nodes 122 are general purpose, programmable data processing units programmed to perform the process the seismic survey traces according to the workflow illustrated schematically in FIGS. 2 and 8. The processor nodes 122 operate under control of the master node 120.

Although the present invention is independent of the specific computer hardware used, an example embodiment of the present invention is preferably based on a master node 120 and processor nodes 122 of an HP Linux cluster computer. It should be understood, however, that other computer hardware may also be used.

The master node 120 and processor nodes 122 access the seismic traces and other input data measurements as described above to perform the logic of the present invention, which are executed as a series of computer-executable instructions. The stored computer operable instructions cause the data processing system D to process the seismic trace gathers by linear convolution according to the present invention. Results of such processing are then available on output display 106. FIG. 9 is an example display of such results from laboratory data.

As has been set forth, the present invention forms the seismic survey results into plane-wave sources and gathers periodically and converts both source and receiver wavefields into periodical waveforms. The present invention avoids the need for circular convolution and the necessity for forming Green's functions, each of which required time consuming it, computer intensive processing. As has been discussed, the present invention provides periodical waveforms formed for plane-wave the sources and gathers, which are susceptible to linear convolution by making two-period intermediate wavefields. The results obtained greatly simplify the data processing in order to perform of plane-wave reverse time migration or RTM, as defined by Equation (2). Further, as has been demonstrated, linearly convolving the intermediate wavefields generates identical results made by circularly convolving the original signals.

The present invention overcomes the long delay time problem of plane-wave reverse time migration by wrapping the plane-wave sources and gathers periodically and dramatically reduces the computation cost of plane-wave reverse time migration. The present invention obtains comparable results to those previously only available through circular convolution. In addition the present invention does not require prior explicit knowledge of the content of the signals being convolved. The present invention can significantly reduce computer resources required, since there is no need for preparing and storing in advance the two signals to be convolved, which was required to known in prior methods.

The present invention quickly provides an image of subsurface features of interest. The present invention also saves computation costs compared to those of circular convolution for reverse time migration. The present invention also provides efficient common image gathers needed for velocity model building. The present invention is thus an efficient tool for migration and velocity model building.

The invention has been sufficiently described so that a person with average knowledge in the field of seismic surveying and exploration may reproduce and obtain the results mentioned herein described for the invention. Nonetheless, any skilled person in the field of technique, subject of the invention herein, may carry out modifications not described in the request herein, to apply these modifications to a determined structure and methodology, or in the use and practice thereof, requires the claimed matter in the following claims; such structures and processes shall be covered within the scope of the invention.

It should be noted and understood that there can be improvements and modifications made of the present invention described in detail above without departing from the spirit or scope of the invention as set forth in the accompanying claims.

What is claimed is:

1. A method of acquisition and processing of seismic traces resulting from a seismic survey to produce an image of a subsurface area indicating subsurface formation structure, comprising the steps of:
conducting the seismic survey to obtain a series of seismic traces related to the subsurface area as an area of interest for drilling wells in subsurface formation structure;
transferring the series of seismic traces for processing;
converting the series of seismic survey traces to plane-wave source traces and plane-wave gathers;
transforming the plane-wave source traces and plane-wave gathers to periodical wavefields;
performing reverse time migration of the transformed periodical wavefields by linear convolution of the transformed periodical wavefields;
forming an output display of an image of the subsurface area indicating subsurface formation structure from the reverse time migrated, transformed periodical wavefields.

2. The method of claim 1, further including the step of storing the reverse time migrated, transformed periodical wavefields.

3. The method of claim 1, further including the step of drilling a well in an area indicated of interest in the image of the subsurface area indicating subsurface formation structure from the reverse time migrated, transformed periodical wavefields.
